(19) United States
(12) Patent Application Publication
(10) Pub. No.: US 2020/0364487 A1
(43) Pub. Date: Nov. 19, 2020

(54) METHOD OF RECOGNIZING OBJECT FOR EACH ADMINISTRATIVE DISTRICT, AND SYSTEM THEREOF

(71) Applicant: Fingram Co.,Ltd, Yongin-si (KR)

(72) Inventor: Young Cheul Wee, Suwon-si (KR)

(21) Appl. No.: 15/930,682

(22) Filed: May 13, 2020

(30) Foreign Application Priority Data
May 13, 2019 (KR) 10-2019-0055480

(51) Int. Cl. G06K 9/46; G06K 9/20

(52) U.S. Cl. CPC G06K 9/4604; G06K 2209/21; G06K 2209/01; G06K 9/2054

(57) ABSTRACT

A method of recognizing an object having a different format according to each administrative district includes the steps of: determining a target administrative district corresponding to the object based on an image of the object by an object recognition system; determining a position of a recognition target object in the image of the object indicating the target administrative district by the object recognition system, the position of the recognition target object set before the step of determining the target administrative district; and performing recognition of the recognition target object at the determined position by the object recognition system.

### CROSS REFERENCE TO RELATED APPLICATION

This application claims priority from and the benefit of Korean Patent Application No. KR 10-2019-0055480, filed May 13, 2019, which is hereby incorporated by reference for all purposes as if fully set forth herein.

### BACKGROUND

### Field

Exemplary implementations of the invention relate an object recognition system and a method thereof, and more specifically, to a system and a method capable of detecting a is position or an outer line of an object.

### Discussion of the Background

There is a growing need for recognition of objects existing in various fields.

Object recognition determines whether an object to be detected exists in an image through object detection, and is also required even in a service for recognizing meaningful information displayed on a detected object.

For example, in order to rapidly and accurately recognize information to be recognized from a captured image in a service of recognizing a card number displayed on a financial card (e.g., a credit card or a check card, etc.) or a driver license plate of a vehicle, it may be effective to detect first where a corresponding object is located in the image.

That is, compared to optical character recognition (OCR) performed on an image itself to recognize meaningful information displayed on the image, if OCR is performed in a predetermined method after the position of a target object is accurately identified, information may be recognized more accurately.

Accordingly, it is required to provide a method capable of detecting a position of an object (an outer line of the object) more effectively.

In addition, when a predetermined recognition target object displayed on a detected object (e.g., text displayed on a financial card) is recognized, binarization may be performed through a predetermined preprocess, and recognition of the recognition target object may be performed through the binarization, and therefore, it is required to provide a system and method capable of effectively performing the binarization.

In addition, there are cases in which the formats (e.g., size, color, display position of information, etc.) are different for each administrative district according to the object type although the objects are the same, and a method and a system for correctly recognizing required information even in this case are required.

The above information disclosed in this Background section is only for understanding of the background of the inventive concepts, and, therefore, it may contain information that does not constitute prior art.

### SUMMARY OF THE INVENTION

Devices constructed and methods according to the principles and exemplary implementations of the invention are capable of detecting a position or an outer line of an object having a specific shape.

Further, the devices constructed and the methods according to the principles and exemplary implementations of the invention are capable of reliably detecting, through local binarization, an object in an environment in which image characteristic of an object greatly affected by illumination or in which the image characteristic of the object varies according to each region of a whole image.

Furthermore, the devices constructed and the methods according to the principles and exemplary implementations of the invention are capable of reliably detecting an object in the case that objects have the same type (e.g., driver license card or the like) and the objects have different formats (e.g., size, color, and display position of information) according to each administrative district. Thus, the devices constructed and the methods according to the principles and exemplary implementations of the invention may have a relatively high recognition performance.

In addition, the devices constructed and the methods according to the principles and exemplary implementations of the invention are capable of accurately detecting an object at a relatively high speed by improving recognition performance even when the format of an object is different for each administrative district.

Additional features of the inventive concepts will be set forth in the description which follows, and in part will be apparent from the description, or may be learned by practice of the inventive concepts.

According to one aspect of the invention, a method of recognizing an object having a different format according to each administrative district, the method includes the steps of: determining a target administrative district corresponding to the object based on an image of the object by an object recognition system; determining a position of a recognition target object in the image of the object indicating the target administrative district by the object recognition system, the position of the recognition target object set before the step of determining the target administrative district; and performing recognition of the recognition target object at the determined position by the object recognition system.

The step of determining the target administrative district corresponding to the object based on the image of the object by the object recognition system, may include the steps of: performing recognition of a predefined administrative district display area in the object; and determining the target administrative district based on a result of performing the recognition of the predefined administrative district display area in the object.

The method may further include the step of identifying an outer line of the object, wherein the object recognition system determines the target administrative district or the position of the recognition target object based on the identified outer line of the object.

The step of identifying the outer line of the object may include the steps of: extracting line segments from the image of the object; generating merged line segments based on directionality of each of the extracted line segments; identifying candidate outer lines with respect to the outer line of the object based on a line segment set including the generated merged line segments; and determining the candidate outer lines as the outer line of the object based on whether or not the identified candidate outer lines correspond to an appearance attribute of the obj ect.

The step of performing the recognition of the recognition target object at the determined position by the object recognition system may include the steps of: determining a target area corresponding to the position of the recognition target object; setting a binarization area and a coefficient calculation area in a part of the target area, the coefficient calculation area including the binarization area and having an area wider than the binarization area by a predetermined ratio; determining a binarization coefficient based on values of pixel images included in the coefficient calculation area; and performing image binarization on the binarization area by using the determined binarization coefficient, wherein the recognition of the recognition target object may be performed based on a result of the image binarization on the binarization area.

A computer-readable recording medium installed in a data processing device may be configured to perform a method as in claim 1.

According to another aspect of the invention, an object recognition system for recognizing an object having a different format according to each administrative district, the system includes: a control module configured to determine a position of a recognition target object in an image of the object indicating a target administrative district, the position of the recognition target object set before determining the target administrative district corresponding to the object; and a recognition module configured to perform recognition of the recognition target object displayed at the determined position.

The control module may be configured to determine the target administrative district based on a result of the recognition of the recognition target object that is performed on a predefined administrative district display area in the object by the recognition module.

The system may further include a detection module configured to identify an outer line of the object, wherein the control module is configured to determine the target administrative district or the position of the recognition target object based on the identified outer line of the object.

The detection module may be configured to extract line segments from the image of the object, to generate merged line segments based on directionality of each of the extracted line segments, to identify candidate outer lines with respect to the outer line of the object based on a line segment set including the generated merged line segments, and to determine the candidate outer lines as the outer line of the object based on whether or not the identified candidate outer lines correspond to an appearance attribute of the object.

The recognition module may be configured to determine a target area corresponding to the position of the recognition target object, to set a binarization area and a coefficient calculation area in a part of the target area, the coefficient calculation area including the binarization area and having an area wider than the binarization area by a predetermined ratio, to determine a binarization coefficient based on values of pixel images included in the coefficient calculation area, to perform image binarization on the binarization area by using the determined binarization coefficient, and to perform the recognition of the recognition target object based on a result of the image binarization on the binarization area.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a schematic view of a logical configuration of an object recognition system constructed according to the principles of the invention.

FIG. 2 is a flowchart schematically illustrating an object detection method according to an exemplary embodiment.

FIG. 3 is a plan view of a region of interest in an object detection method according to an exemplary embodiment.

FIG. 4 is a plan view of extracting line segments according to an exemplary embodiment.

FIG. 5 is a plan view of a merged line segment according to an exemplary embodiment.

FIG. 6 is a plan view of a detected object according to an exemplary embodiment.

FIG. 7 is a plan view of an image formed by warping the detected object of FIG. 6.

FIG. 8 is a flowchart schematically illustrating a method of recognizing a recognition target object according to an exemplary embodiment.

FIG. 9 is a plan view illustrating a method of performing local binarization according to an exemplary embodiment.

FIG. 10 is a plan view illustrating a method of labeling after performing local binarization according to an exemplary embodiment.

FIG. 11 is a plan view illustrating a result of searching for a pattern according to an exemplary embodiment.

FIGS. 12, 13, and 14 are plan views illustrating a method of recognizing an object of a different format for each administrative district according to an exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, the present invention is described in detail focusing on the embodiments of the present invention with reference to the attached drawings. Like reference symbols presented in each drawing denote like members.

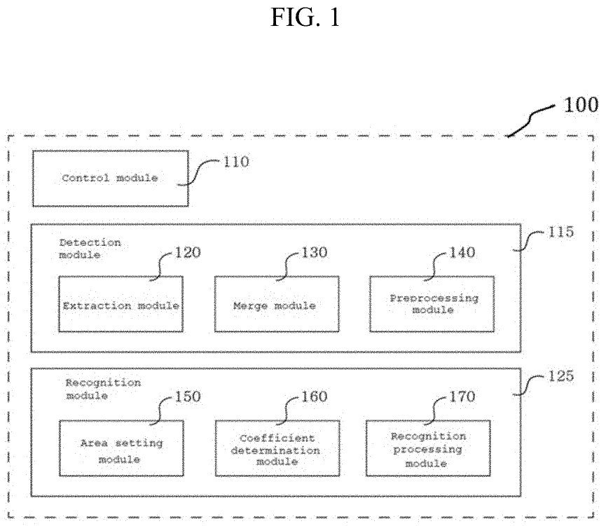

FIG. 1 is a schematic view of a logical configuration of an object recognition system constructed according to the principles of the invention.

Referring to FIG. 1, an object recognition system 100 may be provided an object recognition method according to exemplary embodiments.

The object recognition system 100 (hereinafter, referred to as a recognition system) may detect a desired object from an image. In addition, the recognition system 100 may recognize a target (hereinafter, referred to as a recognition target object) that is desired to be recognized from the detected object.

The recognition system 100 may be installed in a predetermined data processing system according to an exemplary embodiment.

The data processing system may include a system having a computing capability for implementing the exemplary embodiment, but exemplary embodiments are not limited thereto. For example, the data processing system may include any system capable of performing a service using object detection according to the exemplary embodiments, such as a personal computer, a portable terminal, or the like, as well as a network server generally accessible by a client through a network.

Hereinafter, the desired object to be detected will be described as any object, on which private financial information or personal information is displayed, such as a financial card (e.g., a credit card, a check card, etc.) or an identification card (e.g., driver license or the like). The recognition target object will be described as a numeral or text such as a card number or an expiration date printed or embossed on the financial card or the identification card. However, exemplary embodiments are not limited thereto. For example, the exemplary embodiments may be applied to any object having a predetermined shape (e.g., a rectangle or the like).

The data processing system may include a processor and a storage device. The processor may include a computing device capable of driving a program for implementing the exemplary embodiments, and the processor may perform functions defined in this specification by driving the program.

The storage device may include a data storage mean capable of storing the program, and may be implemented as a plurality of storage means according to exemplary embodiments. In addition, the storage device may include a main memory device included in the data processing system, a temporary storage device, or a memory that can be included in the processor.

Referring to FIG. 1, the recognition system 100 is implemented as any one physical device, but exemplary embodiments are not limited thereto. For example, a plurality of physical devices may be systematically combined as needed to implement the recognition system 100 according to the exemplary embodiments.

According to the exemplary embodiments, the recognition system 100 may detect a corresponding object from an image in which objects are displayed. Detecting the corresponding object may include detecting a position of the corresponding object from the image or extracting outer lines configuring the corresponding object.

In addition, the recognition system 100 may recognize a target (i.e., a recognition target object) which is a recognition target in the corresponding object.

The recognition system 100 implemented for this function may have a configuration as shown in FIG. 1.

Referring to FIG. 1, the recognition system 100 may include a control module 110, a detection module 115, and a recognition module 125 according to an exemplary embodiment. For example, the detection module 115 may include an extraction module 120, and a merge module 130, and a preprocessing module 140. For example, the recognition module 125 may include an area setting module 150, and a coefficient determination module 160, and a recognition processing module 170. However, exemplary embodiments are not limited thereto. For example, the recognition module 125 may be omitted from the recognition system. For example, the preprocessing module 140 may be omitted from the detection module 115.

According to another exemplary embodiment, the recognition system 100 may include only the control module 110, the area setting module 150, and the coefficient determination module 160, and may further include the recognition processing module 170 as needed.

In addition, according to exemplary embodiments, the configuration of the recognition system 100 may be divided into the control module 110, the detection module 115, and the recognition module 125. In this case, the detection module 115 may include the extraction module 120, the merge module 130, and a preprocessing module, and the recognition module 125 may include an area setting module 150, a coefficient determination module 160, and a recognition processing module 170. For example, each of the modules defined in this specification may be merged or separately named in various other ways.

The recognition system 100 may have a logical configuration having hardware resources and/or software needed for implementing the exemplary embodiments. For example, the recognition system 100 may not be limited to a physical component or a device. The recognition system 100 may have a logical combination of hardware and/or software provided to implement the exemplary embodiments. For example, the recognition system 100 may be installed in devices spaced apart from each other and perform respective functions to be implemented as a set of logical configurations for implementing the exemplary embodiments. In addition, the recognition system 100 may have a set of components separately implemented as each function or role for implementing the exemplary embodiments. For example, each of the control module 110, the extraction module 120, the merge module 130, the preprocessing module 140, the area setting module 150, the coefficient determination module 160 and/or the recognition processing module 170 may be located in different physical devices or in the same physical device. In addition, according to exemplary embodiments, combinations of software and/or hardware configuring each of the control module 110, the extraction module 120, the merge module 130, the preprocessing module 140, the area setting module 150, the coefficient determination module 160 and/or the recognition processing module 170 may also be located in different physical devices, and components located in different physical devices may be systematically combined with each other to implement each of the above modules.

In addition, a module may include a functional and structural combination of hardware for performing the exemplary embodiments and software for driving the hardware, but exemplary embodiments are not limited thereto. For example, the module may include a logical unit of a predetermined code and hardware resources for performing the predetermined code. The module may not be limited to a physically connected code or a kind of hardware.

The control module 110 may control the components (e.g., the extraction module 120, the merge module 130, the preprocessing module 140, the area setting module 150, the coefficient determination module 160 and/or the recognition processing module 170) included in the recognition system 100 or manage their functions and/or resources to implement the exemplary embodiments.

The recognition system 100 may know in advance a shape of an object to be detected. In addition, the recognition system 100 may detect an object with the shape.

Hereinafter, although a case in which the object is a financial card is described as an example as below, exemplary embodiments are not limited thereto. For example, the exemplary embodiments may be used to detect various objects having a predetermined shape.

The extraction module 120 may extract line segments from an image. The shape of the object is set in the extraction module 120 in advance, and since the object may be a rectangle according to the exemplary embodiments, the boundary of the object may be a straight line. Therefore, the extraction module 120 may extract line segments that may be all or part of the outer line, which are straight lines forming the boundary of the object, from the image.

The method of extracting the line segments from the image may include various other methods. For example, edges displayed in the image may be detected through edge detection, and line segments may be extracted by extracting non-curved lines among the detected edges. Some of the extracted line segments may be all or part of the outer line, and all the line segments extracted according to the image features displayed in the object, not the outer line, or the line segments extracted by the image features existing outside the object may be included.

In addition, predetermined preprocessing may be performed on the image photographed by an image capturing apparatus to extract these line segments more effectively.

For example, the preprocessing module 140 may separate channels for respective colors (e.g., R, G, B or y, cb, cr, etc.) in the original image photographed by the image capturing apparatus. In addition, according to exemplary embodiments, the preprocessing module 140 may further perform a predetermined filter processing. Then, the extraction module 120 may extract line segments from any one or a plurality of preprocessed images.

Further, since the object has a predetermined shape and the position of each of the outer lines is limited according to the shape, the extraction module 120 may extract line segments from each region, in which the outer lines are likely to be located, for more effective and faster detection of the object. Each region, in which the outer lines are likely to be located, will be defined as a region of interest (ROI).

For example, when the object is a rectangular financial card, the outer line of the financial card may have an upper side, a lower side, a left side, and a right side. A corresponding region of interest (ROI) may be assigned to each of the outer lines.

When a region of interest is assigned like above and the line segments are extracted from each region of interest or the line segments are merged as described below, the object may be detected within a shorter time. This is why the direction of the outer line may be specified in advance for each region of interest.

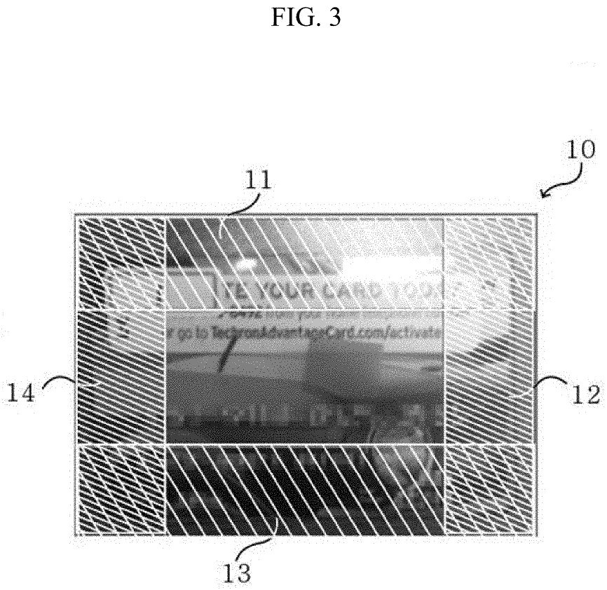

FIG. 3 is a plan view of a region of interest in an object detection method according to an exemplary embodiment, and when the object is a financial card as shown in FIG. 3, four regions of interest 11, 12, 13 and 14 may be set in the image 10. Each of the regions of interest 11, 12, 13 and 14 may be a region in which each of the outer lines of the financial card may exist. For example, the regions of interest 11, 12, 13 and 14 may be set as regions with a suitable size so that at least one outer line may be included.

According to an exemplary embodiment, the extraction module 120 may extract line segments only from the set regions of interest 11, 12, 13 and 14, or may extract line segments from the entire image and select only the segments included in the regions of interest 11, 12, 13 and 14. According to exemplary embodiments, the extraction module 120 may extract line segments from the entire image, and the merge module 130 may select only the line segments belonging to the regions of interest 11, 12, 13 and 14 among the extracted line segments and use the selected segments as a target of merge.

For example, each of the line segments extracted from the image may be managed to confirm to which region of interest 11, 12, 13, and 14 the line segments belong.

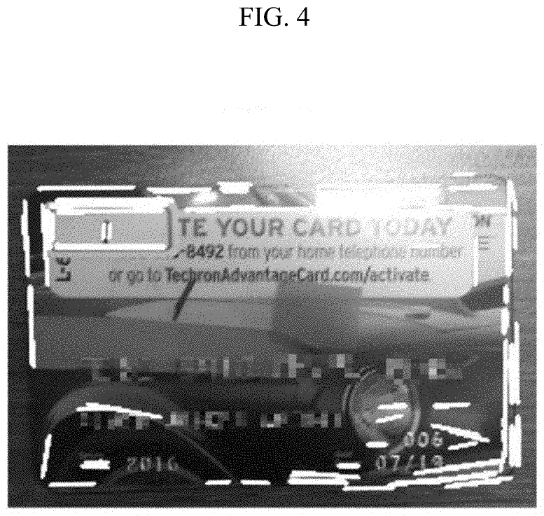

FIG. 4 is a plan view of extracting line segments according to an exemplary embodiment. As shown in FIG. 4, the extraction module 120 may extract line segments separately for each of the regions of interest 11, 12, 13 and 14, and the extracted line segments may be as shown in FIG. 4

Then, the merge module 130 included in the recognition system 100 may generate a merged line segment based on the extracted line segments. The merge module 130 may generate merged line segments based on the directionality of each of the extracted line segments.

In addition, the merge module 130 may generate a merged line segment for each region of interest (ROI). Generating a merged line segment for each region of interest may include that a merged line segment corresponding to any one region of interest (e.g., a first region of interest 11) is generated by merging only the line segments extracted from the region of interest (e.g., the first region of interest 11).

The merge module 130 may generate a merged line segment from the extracted line segments because a case in which one outer line of an object is cut into a plurality of pieces and detected as a plurality of line segments is more frequent than a case in which the outer line of the object is wholly extracted as a single line segment according to the state or the photographing environment of an image. Accordingly, generating a merged line segment may be to find out which line segments among the line segments extracted or selected for each of the regions of interest 11, 12, 13 and 14 are the line segments corresponding to the outer line.

For example, as shown in FIG. 4, each of the upper side, the lower side, the left side, and the right side of the financial card may not be detected as a single line segment, but each one side may be extracted as a plurality of broken line segments.

For example, since the directionality of an outer line corresponding to each of the regions of interest 11, 12, 13, and 14 is already determined before a merged line segment is generated, the merge module 130 may exclude line segments, which have a big difference in the directionality with an outer line of a corresponding region of interest among the extracted line segments, from the target of merge. According to exemplary embodiments, the extraction module 120 may substantially delete the line segments, which have a big difference from the direction of the outer lines corresponding to the regions of interest 11, 12, 13 and 14 from the extracted line segments.

The merge module 130 and/or the extraction module 120 may exclude line segments with a directionality corresponding to each of the regions of interest 11, 12, 13 and 14, i.e., line segments with a predetermined or larger slope with respect to an outer line, from the target of merge or substantially delete them from the extracted segments. For example, the outer lines corresponding to the first region of interest 11 and the third region of interest 13 may be the upper side and the lower side and have a direction close to the horizontal line although they are projected onto the camera plane. In this case, among the line segments extracted from the first region of interest 11 and the third region of interest 13, line segments inclined more than a predetermined angle (e.g., 30 degrees, 45 degrees, etc.) from the horizontal line may be excluded from the target of merge or substantially deleted from a list of extracted line segments.

In addition, the outer lines corresponding to the second region of interest 12 and the fourth region of interest 14 may be the right side and the left side of the financial card and have a direction close to the vertical line although they are projected onto the camera plane. In this case, among the line segments extracted from the second region of interest 12 and the fourth region of interest 14, the line segments inclined more than a predetermined angle (e.g., 30 degrees, 45 degrees, etc.) from the vertical line may be excluded from the target of merge or substantially deleted from the list of extracted line segments.

Then, the merge module 130 may generate a merged line segment for each of the regions of interest 11, 12, 13 and 14.

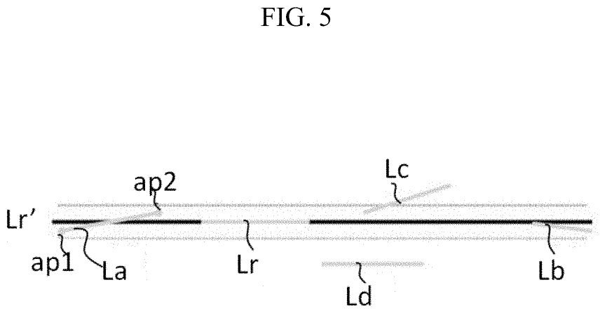

An example of generating the merged line segment by the merge module 130 will be described in detail with reference to FIG. 5.

FIG. 5 is a plan view of a merged line segment according to an exemplary embodiment.

Referring to FIG. 5, the merge module 130 may merge line segments with a directionality which satisfy a reference condition among the remaining line segments in each region of interest. For example, the remaining line segments may be line segments remaining after deleting the line segments excluded from the target of merge since there is a big difference from the directionality of a corresponding region of interest.

The reference condition may be merging line segments, which have the same directionality or similar directionality as much as to satisfy a predetermined reference condition, among the remaining line segments in each of the regions of interest 11, 12, 13 and 14.

For example, when the merge module 130 generates a merged line segment from the first region of interest 11, as shown in FIG. 5, it may select any one line segment Lr, i.e., a reference line segment, among the line segments presently remaining in the first region of interest 11. For example, a line segment, which has a directionality most similar to the directionality (e.g., a horizontal line) of a corresponding region of interest 11, i.e., closest to the horizontal line, may be selected first as the reference line segment Lr. According to exemplary embodiments, the merging process may be performed by sequentially setting reference line segments for all or some of the line segments. Further, FIG. 5 illustrates a first line segment La, a second line segment Lb, a third line segment Lc, and a fourth line segment Ld.

Then, the merge module 130 may select other line segments of the first region of interest 11, which satisfy a predetermined condition in directionality with respect to the reference line segment Lr, among the first, second, third, and fourth line segments La, Lb, Lc, and Ld.

For example, in order to determine whether the directionality of the other line segments satisfies the predetermined condition, an angle formed by the reference line segment Lr (or an extension line Lr′ extended from the reference line segment Lr) and the other line segments may be used. In this case, a condition for crossing or intersecting the extension line Lr′ and the other line segment should be added, or a condition related to distance may need to be additionally defined.

Alternatively, when the orthogonal distances between the extension line Lr′ and both end points (e.g., ap1 and ap2) of the first line segment La are smaller than or equal to a predetermined threshold value, respectively, it may be determined that the first line segment La satisfies the predetermined condition.

Referring to FIG. 5, the first line segment La and the second line segment Lb may be line segments satisfying the predetermined condition in the directionality with respect to the reference line segment Lr. The third line segment Lc and the fourth line segment Ld may be line segments that do not satisfy the predetermined condition in the directionality with respect to the reference line segment Lr.

Then, the reference line segment Lr, the first line segment La, and the second line segment Lb may be line segments that can be merged.

The merged line segment may be the sum of the lengths of the first and second line segments La and Lb, having the direction of the reference line segment Lr and having a length that may be merged with the length of the reference line segment Lr, with respect to the direction of the reference line segment Lr.

For example, the lengths of the first and second line segments La and Lb with respect to the direction of the reference line segment Lr may be the lengths obtained by projecting the first and second line segments La and Lb that can be merged with the extension line Lr′.

Then, the generated merged line has the direction of the reference line segment Lr, and the length may be the sum of the length of the reference line segment Lr, the projection length of the first line segment La with respect to the extension line Lr′, and the projection length of the second line segment Lb with respect to the extension line Lr′. For example, the projection lengths of the first and second line segments La and Lb may obtained by projecting the first and second line segments La and Lb on the extension line Lr′, respectively.

According to an exemplary embodiment, the merge module 130 may generate at least one merged line segment in the first region of interest 11 by changing the reference line segment while maintaining the merged line segment without deleting the merged line segment from the list of the line segments of the first region of interest 11.

In this manner, the merge module 130 may generate at least one merged line segment for each of the regions of interest 11, 12, 13, and 14. Then, segment sets in which the merged segments and the original segments are maintained for each of the regions of interest 11, 12, 13 and 14 may be maintained.

Thereafter, the control module 110 may extract line segments that may be all or part of the actual outer line of the object one by one according to each of the regions of interest 11, 12, 13 and 14. For example, the line segments may be extracted one by one from the segment set maintained in each of the regions of interest 11, 12, 13, and 14. The extracted line segments may be all or part of the outer line of each region of interest 11, 12, 13, or 14.

In this case, since the longest line segment among the set of segments is likely to be all or part of an actual outer line, it may be effective for the control module 110 to sequentially extract the line segments in order of length from the segment sets of each of the regions of interest 11, 12, 13, and 14.

In addition, since even the longest merged line segment may be shorter than the length of the outer line of the actual object, the control module 110 may specify the outer line of the shape formed by the extension lines of the line segments extracted from the regions of interest 11, 12, 13 and 14, i.e., the outer line of a candidate figure, as a candidate outer line. For example, the longest line segments are extracted one by one from each of the regions of interest 11, 12, 13 and 14, and a candidate outer line is specified based on the extracted line segments. When it is determined that the candidate outer line is not an outer line of the actual object, a process of sequentially extracting the next longest line segment and specifying a candidate outer line may be repeated while changing the region of interest. For example, the order and/or the method of extracting a line segment to specify a candidate outer line for each of the regions of interest 11, 12, 13 and 14 may be changed according to exemplary embodiments. For example, a line segment may be extracted from each of the regions of interest 11, 12, 13 and 14 in various other ways, and an outer line of a figure formed by an extension line of the extracted line segment may be specified as a candidate outer line.

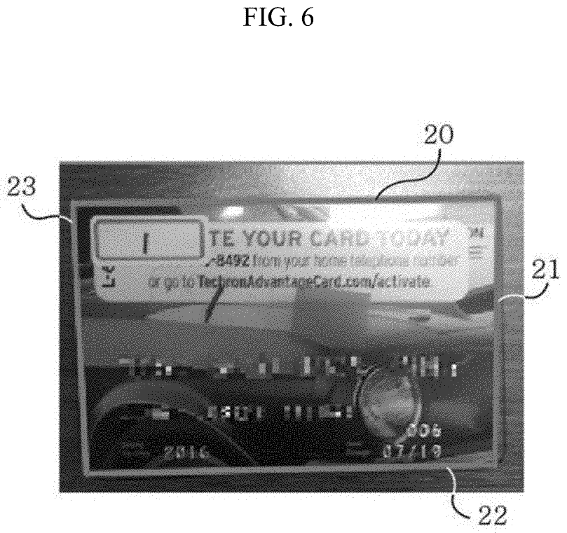

An example of a specific candidate outer line may be as shown in FIG. 6.

FIG. 6 is a plan view of a detected object according to an exemplary embodiment.

FIG. 6 shows a case in which a specific candidate outer line is an outer line of an actual object, and the specified candidate outer lines 20, 21, 22 and 23 may be extension lines of the line segments extracted from the regions of interest 11, 12, 13 and 14, respectively. In addition, a figure formed by the extension lines may be a candidate figure as shown in FIG. 6.

Then, the control module 110 may determine whether the appearance of the candidate figure corresponds to the appearance attribute of the object to be detected. For example, it may be determined whether specific candidate outer lines 20, 21, 22 and 23 correspond to the appearance attributes of the object.

For example, in the case of a financial card, the appearance attribute may be a predetermined aspect ratio (for example, 1.5858:1 in the case of ISO7810), and the control module 110 may determine whether a figure formed by the specific candidate outer lines conforms with the appearance attribute.

When it is determined that the candidate figure, i.e., the candidate outer lines, corresponds to the appearance attribute of the object, corresponding candidate outer lines may be determined as the outer lines of the actual object.

In this case, since the candidate outer lines are line segments extracted from the image of the actual object, which is projected on the camera plane, although the candidate outer lines are the outer line of the actual object, the length of the outer line of the image of the actual object may be distorted. For example, although the actual object is a rectangular shape and the candidate outer lines are the outer lines of the actual object, the outer lines of the image of the object projected onto the camera plane may not be a rectangular shape.

Accordingly, it needs to adjust the distortion to more accurately determine whether a candidate figure or candidate outer lines correspond to the appearance attribute (e.g., a fixed aspect ratio of a rectangle) of the actual object.

For example, the control module 110 may use the length ratio of the candidate outer lines as the appearance attribute to determine whether the current candidate outer lines correspond to the appearance attribute of the actual object.

In this case, the length ratio of the candidate outer lines may be a length ratio of each of the candidate outer lines with respect to all the candidate outer lines constituting the candidate figure, or a length ratio of some (e.g., any one of the horizontal sides and any one of the vertical sides) of the candidate outer lines. Alternatively, the length ratio of the candidate outer lines may be a length ratio obtained by a predetermined operation performed on at least some of the candidate outer lines. In any case, the term “length ratio” herein is calculated based on the length of a line segment (outer line) of a specific figure and may mean a unique value of the specific figure.

For example, as described above, when the object is a financial card, the financial card may have a length ratio of 1.5858:1 as a length ratio of a horizontal side of the financial card to a vertical side thereof. Accordingly, the length ratio of the candidate outer lines may also be defined as any value if the value may confirm whether the length ratio of the horizontal outer line to the vertical outer line corresponds to the length ratio of the horizontal side of the financial card to the vertical side thereof.

In an exemplary embodiment, it may be determined whether the sum of length of the horizontal outer lines and the sum of length of the vertical outer lines among the candidate outer lines corresponds to the length ratio of the financial card. The correspondence may be determined as a case in which the difference between the ratio of the sum of length of the horizontal outer lines to the sum of length of the vertical outer lines among the candidate outer lines and the length ratio of the financial card is equal to or smaller than a predetermined threshold value.

In this case, the length ratio of the financial card may also be defined as the ratio of the sum of the horizontal outer lines to the sum of the vertical outer lines, and when the object has a rectangular shape, the length ratio may be a value equal to the ratio of the length of any one of predetermined horizontal outer lines to the length of any one of predetermined vertical outer lines. However, since a predetermined distortion occurs while the candidate outer lines are projected on the camera plane as described above, the two horizontal outer lines (or vertical outer lines) may not have the same length, and thus it may be effective to use the ratio of the sum of length of the two horizontal outer lines (or vertical outer lines) as the length ratio.

In addition, since the calculation speed of accurately calculating inverse projection is very slow, there is an effect of calculating in a short time in the case of calculating an approximate value using the sum of length of the horizontal outer lines and the vertical outer lines.

In order to compensate for the distortion of an image of an object projected on the camera plane by using the approximation value, the angle of vertices (e.g., four corners) of the candidate figure may be used.

In the case where the actual object is rectangular, internal angles of vertices of the image of the actual object may be ideally 90 degrees. However, as the differences between the internal angels of the vertices of the image of the actual object from 90 degrees, the amount of the distortion in length of the outer lines connected to the vertex may be increased.

Accordingly, the control module 110 may correct the length of at least one of the outer lines based on the differences between the internal angels of the vertices of the image of the actual object from 90 degrees (e.g., the difference between the internal angle of the vertex of the actual object and the internal angle of the vertex of the candidate figure), and calculate a value of the length ratio of the candidate outer lines based on the corrected length.

Regarding Equation 1 as below, sum_w may be defined as a sum of two horizontal outer lines (e.g., 20 and 22 of FIG. 6) among the candidate outer lines of the candidate figure.

In addition, sum_h may be defined as a sum of two vertical outer lines (e.g., 21 and 23 of FIG. 6) among the candidate outer lines.

In addition, aver_angle_error may be an average of a difference value between the angles of four vertices of the candidate figure and the internal angle (e.g., 90 degrees) of the vertex of the actual object.

In addition, diff_w may be a difference value between two horizontal outer lines (e.g., 20 and 22 of FIG. 6) among the candidate outer lines, and diff_h may be a difference value between two vertical outer lines (e.g., 21 and 23 of FIG. 6) among the candidate outer lines.

Then, the length ratio corrected based on the angles of four vertices of the candidate figure may be defined as follows.

card_wh_ratio={sum_w×(1-sin(aver_angle_error x diff_w_ratio))}/{ sum_h×(1-sin(aver_angle_error x diff_h_ratio))} [Equation 1]

Here, diff_w_ratio is diff_w/(diff_w+diff_h), diff_h_ratio may be defined as 1-diff_w_ratio.

When the corrected length ratio is within a predetermined threshold value from the length ratio 1.5858/1 of the financial card, it may be determined that the candidate outer lines correspond to the appearance attribute of the financial card.

Then, the candidate outer lines may be detected as the outer lines of the object in an image. For example, a candidate figure may be detected as an object (or a position of the object).

When the candidate outer lines do not correspond to the appearance attribute of the object, the control module 110 may detect an object until the object is detected or by repeating a predetermined number of times while changing the candidate outer lines.

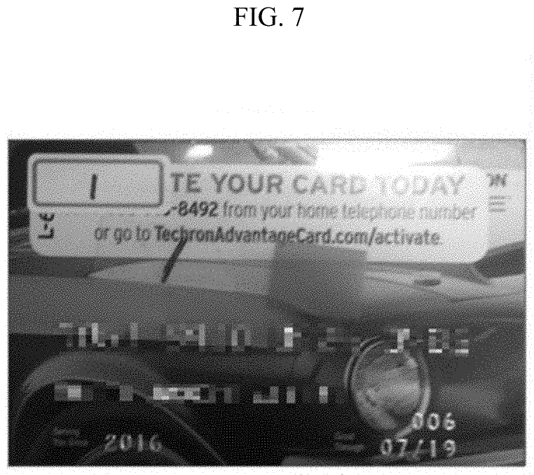

When an object in an image is detected, according to exemplary embodiments, the control module 110 may warp the distorted object to have an original appearance attribute of the object. An example of the warping result is illustrated in FIG. 7.

After warping is performed like above, an application service using the detected object can be more effectively performed.

For example, since features of an object in an image are precisely displayed at the normalized positions without distortion, recognition or detection of the features (e.g., a card number, an expiration date, etc.) displayed in the object may be faster and more accurate performed.

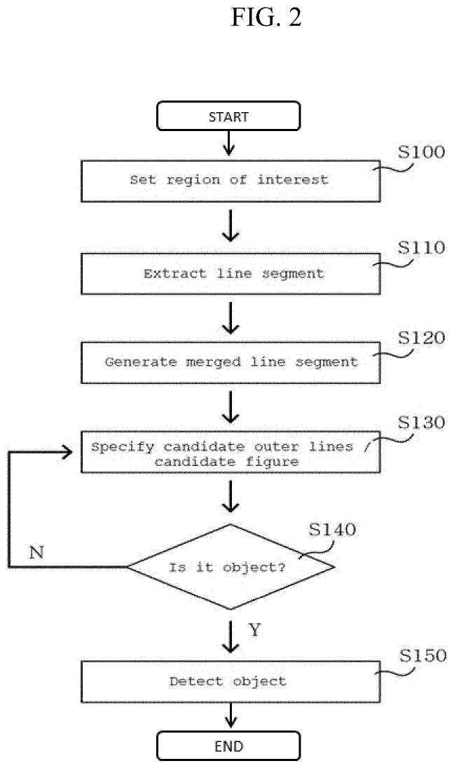

The method of detecting an object according to the exemplary embodiments described above may be summarized overall as shown in FIG. 2.

FIG. 2 is a flowchart schematically illustrating an object detection method according to an exemplary embodiment.

Referring to FIG. 2, the recognition system 100 according to the exemplary embodiments may extract line segments from an image in which an object is displayed (S110).

In this case, the recognition system 100 may set regions of interest 11, 12, 13 and 14 of the image, and extract line segments for each of the set regions of interest 11, 12, 13 and 14 as described above (S100). According to exemplary embodiments, the line segment may be extracted from the whole image, and only the line segments in the regions of interest 11, 12, 13 and 14 may be left among the extracted line segments.

Then, the recognition system 100 may generate merged line segments according to the regions of interest 11, 12, 13 and 14 (S120). Then, a segment set including the generated merged line segments may be maintained in each of the regions of interest 11, 12, 13 and 14.

Then, the recognition system 100 may extract line segments from each of the regions of interest 11, 12, 13 and 14, and specify or identify a candidate figure and/or candidate outer lines formed by the extension lines of the extracted line segments (S130).

Then, it may be determined whether the identified candidate figure and/or candidate outer lines are an object to be detected (S140). In order to determine whether the candidate figure and/or the candidate outer lines corresponds to the appearance attribute of the object o may be determined, the length ratio of the candidate outer lines may be used. In addition, as described above, the length ratio of the candidate outer lines may be corrected according to the distortion degree of the internal angle of the vertex of the identified candidate figure.

In addition, when it is determined that the candidate outer lines are an object to be detected, the candidate outer lines are determined as the outer lines of the object, and the object detection process may be terminated (S150). When it is determined that the candidate outer lines are not an object to be detected, the process of re-setting the candidate outer lines and re-determining whether the re-set candidate outer lines are an object to be detected (S140) may be repeated.

For example, when detection of the object is completed, the recognition system 100 may recognize meaningful information displayed in the object. The meaningful information to be recognized is defined as a recognition target object. For example, the recognition target object may be meaningful text such as a card number, an expiration date, or a name displayed on the financial card. For example, the recognition target object may be meaningful information (e.g., name, driver license number, date of birth, etc.) displayed in a predetermined identification card (e.g., a driver license card).

According to the exemplary embodiments, the recognition system 100 may perform image binarization (e.g., local binarization) to recognize a recognition target object. The image binarization includes a process of changing a pixel value to a value of 0 or 1 (e.g., black and white), and it is known that when the image binarization is performed, a recognition target object can be recognized with higher accuracy.

However, in the case where the image binarization is uniformly performed on the entire detected object, when the image feature changes greatly according to the lighting environment, or when only a specific area has a characteristic different from the image feature of the entire image (e.g., when a background pattern does not exist in the specific area although a background pattern exists in other areas), there may be a problem in which images including the meaningful information (i.e., the recognition target object) disappear through the image binarization. For example, when the object is a financial card, the recognition target object may be a card number displayed in the financial card and embossed on the financial card. Thus, the light reflection characteristic on the embossed card number may be changed according to the lighting. Thus, the area of the embossed card number may have the light reflection characteristic different from those of the other areas of the financial care. As a result, when the image binarization is performed on the entire object (e.g., the financial card), the portions with the different light refection characteristic (e.g., the embossed card number of the financial card) may be determined as unnecessary pixel images.

Therefore, the recognition system 100 according to the exemplary embodiments may perform local binarization.

According to the exemplary embodiments, the recognition system 100 may perform image binarization on a binarization target area in a detected object. Although the binarization target area may be the entire detected object, only a part of the object may be set as the binarization target area when there is a predetermined condition such that a recognition target object exists only at a specific position within the object. For example, as described below, there may be cases in which the formats (e.g., size, color, position of displayed information, etc.) are different according to each administrative district although the objects have the same type. Thus, the binarization target area may be changed according to each administrative district (which issues driver license cards).

According to an exemplary embodiment, the recognition system 100 does not binarize the entire binarization target area using any one binarization coefficient, but sets a portion of the region, determines a binarization coefficient to be used in the set region, and performs image binarization. Thereafter, the recognition system 100 may determine a new binarization coefficient and perform image binarization using the determined new binarization coefficient while moving the set region. For example, the binarization coefficient which becomes a criterion of image binarization may vary in each area and be adjusted according to each area. Thus, using the adjusted binarization coefficient according to each area may prevent the image binarization from being incorrect according to lighting characteristics or regional characteristics.

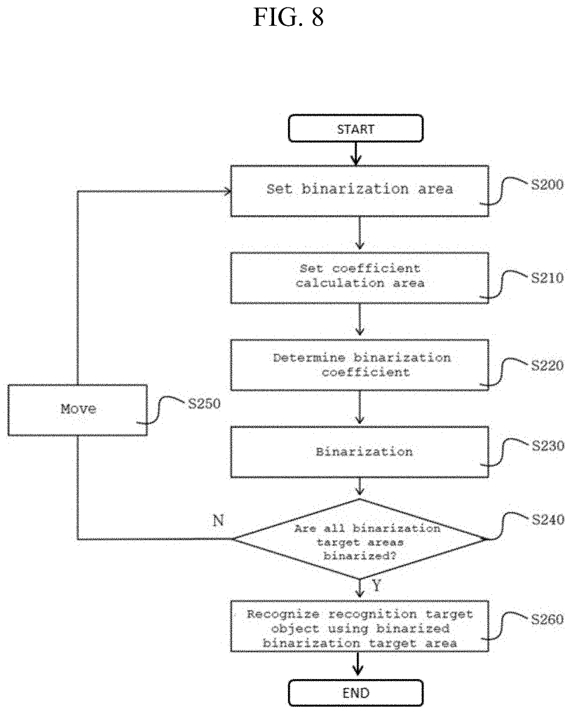

More detail explanations will be described with reference to FIG. 8.

FIG. 8 is a flowchart schematically illustrating a method of recognizing a recognition target object according to an exemplary embodiment.

Referring to FIG. 8, the area setting module 150 included in the recognition system 100 may set a binarization area from an image corresponding to an object (S200). As described above, the binarization area may be set in a portion of a binarization target area predefined in the image.

The image may be, for example, an image in which only a preselected channel (e.g., a gray channel) is separated from a camera preview image. The preprocessing module 140 may separate the preselected channel from the original image of the detected object and use the separated channel image for object recognition. In addition, when the recognition target object is embossing text (including numerals), the image binarization may not be easy in general due to the three-dimensional shape of the embossing text. In addition, since the image binarization may be variously affected by lighting according to the three-dimensional shape of the embossing text, the preprocessing module 140 may perform object recognition as described below after applying a predetermined filter (e.g., Sobel, Scharr, etc.) so that the lighting effect and the embossing text may be expressed well in the image of the separated channel.

Then, the area setting module 150 may set a coefficient calculation area based on the set binarization area (S210).

According to an exemplary embodiment, the coefficient calculation area may be set to include a first binarization area and have an area wider than the first binarization area by a predetermined ratio.

According to an exemplary embodiment, the binarization area may be determined according to the size of the recognition target object. For example, when the recognition target object is a numeral or text and the binarization area is determined based on the size of the numeral or text, the binarization area may be set to have an area equal to or larger than the size of the numeral or text by a predetermined ratio. In addition, according to the shape of the recognition target object, the shape of the binarization area may be set to correspond to the shape of the recognition target object.

Then, the coefficient calculation area may be set to also include the binarization area and may have the same shape as that of the binarization area.

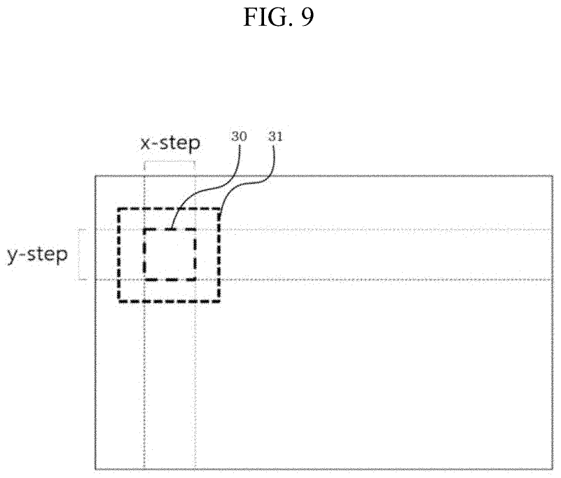

An example of the binarization area and the coefficient calculation area may be as shown in FIG. 9.

FIG. 9 is a plan view illustrating a method of performing local binarization according to an exemplary embodiment.

As shown in FIG. 9, the area setting module 150 may set a binarization area 30 in an area of the binarization target area. The area setting module 150 may set a coefficient calculation area 31 including the binarization area 30 and wider than the binarization area 30 by a predetermined ratio.

However, when the coefficient calculation area 31 is not wider than the binarization area 30 or when the binarization coefficient is determined based only on the binarization area 30, the image binarization may be discontinued between the binarization areas of the binarization target area since a binarization result of an image feature existing across at least two adjacent binarization areas is different when different binarization coefficients are applied to each of the at least two adjacent binarization areas. Accordingly, when the coefficient calculation area is set to have an area wider than the binarization area, there is an effect of solving this problem by commonly considering the coefficient calculation area, which is wider than the binarization area, when binarization coefficients of a specific binarization area and an area adjacent to the specific binarization area are calculated.

In another exemplary embodiment, the binarization coefficient may be determined using only the pixel images existing in the binarization area according to the characteristics of the object or the characteristics of the recognition target object. In this case, the area setting module 150 only needs to set the binarization area, and it is not need to set the coefficient calculation area.

Although it is shown in FIG. 9 as an example that the coefficient calculation area 31 has a center the same as that of the binarization area 30, a shape the same as that of the binarization area 30, and a width set to be larger by a predetermined ratio (e.g., 10%, 20%, etc.), exemplary embodiments are not limited thereto. For example, the position, the shape, and the size of the coefficient calculation may be variously modified according to exemplary embodiments.

Then, the coefficient determination module 160 may determine a binarization coefficient that will be used as a reference for performing the image binarization on the binarization area 30, based on the pixel values included in the coefficient calculation area 31 (S220).

According to an exemplary embodiment, the binarization coefficient may be determined between an average value and a maximum value of pixel values included in the coefficient calculation area 31.

For example, the binarization coefficient may be calculated by an Equation 2 as below.

Binarization coefficient=Average value+(Maximum value−Average value)×Constant [Equation 2]

Here, Constant is a value between 0 and 1 and may be variously determined according to exemplary embodiments.

Then, the control module 110 may binarize the binarization area 30 using the determined binarization coefficient (S230). For example, a pixel value smaller than the binarization coefficient may be set to 0, and a pixel value greater than or equal to the binarization coefficient may be set to 1.

Thereafter, the control module 110 determines whether the image binarization of the binarization target area is completed (S240), and if not, the control module 110 controls the area setting module 150 to move the position of the binarization area 30 (S250). For example, the moved position may be also within the binarization target area.

For example, the area setting module 150 may set a new binarization area by moving the binarization area as much as the horizontal length or the vertical length of the binarization area 30 from the initial position of the binarization area 30. The coefficient calculation area is set as described above for the newly set binarization area, and the coefficient determination module 160 determines a binarization coefficient, and the control module 110 may perform the image binarization on the newly set binarization area using the determined binarization coefficient. For example, the new binarization area and coefficient calculation area may have the same size and shape as those of the previous binarization area and coefficient calculation area. For example, the method of determining the binarization coefficient may be the same although the binarization area is moved.

The binarization may be performed until binarization of the binarization target area is completed while repeatedly moving the binarization area in this manner.

When binarization of the binarization target area is completed, the recognition processing module 170 may perform recognition of the recognition target object using a binarized result image, i.e., an image of the binarized binarization target area (S260). For example, the binarization target area may be the entire object.

The method of recognizing a recognition target object existing in the binarization target area may be varied.

According to an exemplary embodiment, the recognition processing module 170 may perform labeling (e.g., connected component labeling) on the binarization target area on which the image binarization has been performed. For example, the recognition processing module 170 may recognize recognition target objects, which exist in the binarization target area where binarization has been performed through OCR or the like of various known methods, in various other ways.

The labeling includes a process of grouping pixels having the same pixel value in a binarized image, and the connected component labeling includes an algorithm for grouping connected pixels having the same pixel value into one object. The things existing in the binarization target area may be extracted through the labeling.

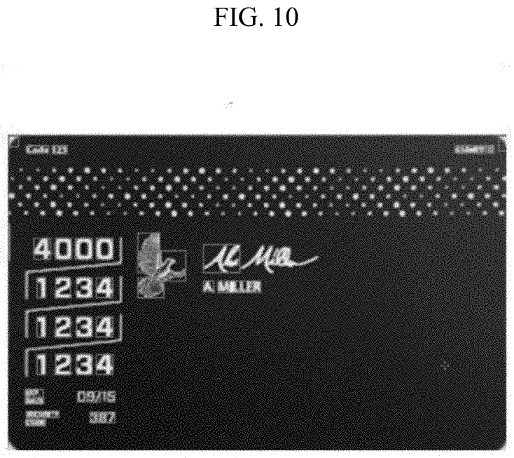

An example of the labeling is shown in FIG. 10.

FIG. 10 is a plan view illustrating a method of labeling after performing local binarization according to an exemplary embodiment.

FIG. 10 exemplarily shows an object (e.g., an entire financial card) in which a binarization target area is detected, and exemplarily shows a result of labeling the binarization target area binarized through the local binarization as described above.

In addition, the things extracted as a result of the labeling may be those indicated as a box as shown in FIG. 10.

Then, the recognition processing module 170 may search for a unique pattern of the recognition target object to be recognized based on the position of the extracted things.

For example, when the recognition target object is a card number, each of the numerals included in the card number may have a display characteristic in which the numerals included in the card number are the same or similar in size and displayed in a uniform shape. A set of the things having such a display characteristic may be the pattern.

Then, the recognition processing module 170 may search for the pattern from the extracted things.

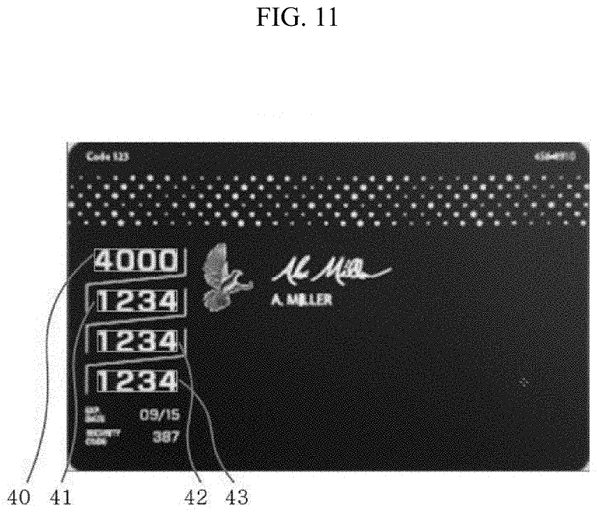

The result of performing the pattern searched like above is shown in FIG. 11.

FIG. 11 is a plan view illustrating a result of searching for a pattern according to an exemplary embodiment.

Referring to FIG. 11, the patterns 40, 41, 42 and 43 are searched by the recognition processing module 170.

When at least one pattern is searched in this manner, the recognition processing module 170 may perform recognition (e.g., OCR) on the searched patterns. The recognition processing module 170 may perform the OCR function by itself, or may input the searched patterns into a separately provided recognition means having an OCR function to obtain a result according to the input, i.e., a recognition result.

In addition, the recognition processing module 170 may input the searched patterns into the recognition means, or may input each of the things, i.e., numerals, included in the pattern into the recognition means. Various exemplary embodiments may be implemented according to the design of the recognition means.

For example, although a case of setting a coefficient calculation area when local binarization is performed has been described as above, but exemplary embodiments are not limited thereto. For example, it may not need to necessarily set the coefficient calculation area.

Then, the area setting module 150 may set only a binarization area having a preset size in a portion of a binarization target area in the image in which a recognition target object is displayed.

The coefficient determination module 160 may determine a binarization coefficient for the binarization area described above based on the values of the pixel images included in the set binarization area.

Then, after performing image binarization on the binarization area using the determined binarization coefficient, the control module 110 may control the area setting module 150 and the coefficient determination module 160 to move the binarization area and determine a new binarization coefficient for the moved binarization area until the image binarization of the binarization target area is completed, and perform the image binarization on the moved binarization area by the determined new binarization coefficient.

In any case, according to the exemplary embodiments, as the image binarization is performed by adaptively selecting a binarization criterion for some areas, instead of performing the image binarization for all objects based on a single uniform criterion, there is an effect of having object recognition accuracy robust in an environment having a different image feature only in a specific area.

For example, even in the case of objects of the same type, there may be cases in which the format of an object is different according to each administrative district. For example, a US driver's license card has a different format in each state, USA. In this case, when meaningful information in the US driver's license card for authenticating an individual is desired to be recognized from an image captured from the driver license, since the positions of the meaningful information in the US driver's license card are all different, and the fonts, the colors, the backgrounds and the like are all different, the accuracy may be significantly reduced when simply OCR is performed on the entire object without considering the difference.

Therefore, according to the exemplary embodiments for higher recognition performance, in order to recognize meaningful information displayed in an object having a different format according to each administrative district, the control module 110 included in the recognition system 100 may first specify or identify a target administrative district corresponding to the object based on an image in which the object is displayed. For example, the control module 110 may utilize calculation results of the detection module 115 and/or the recognition module 125 to specify or identify the target administrative district.

In addition, the control module 110 may predefine information about a position of an area, in which each target administrative district is recorded. At this point, the position of the area for indicating each target administrative district may be a relative position in the object. For example, when the outer lines of the object are specified as described above, the relative position information to be recognized with respect to a predetermined reference position (e.g., upper edge or predetermined vertex) may be defined in advance in the control module 110 based on the outer lines.

Then, the detection module 115 included in the recognition system 100 may detect an object as described above. In addition, the control module 110 may specify or identify the relative position using a detection result.

Then, the recognition module 125 may recognize the recognition target object at the relative position. Then, the recognition module 125 may perform local binarization. For example, it is also possible to perform recognition of the recognition target object included at the relative position in a different way without performing the local binarization.

When the local binarization is performed as described above, the relative position may be set as a binarization target area as described above.

As a result, according to the exemplary embodiments, there is an effect of having a more improved recognition performance by specifying first an administrative district of an object, specifying a position for performing recognition for each administrative district, and then performing recognition at the specified position. In addition, there is an advantage that unnecessary information displayed in the object is not recognized.

For example, in order for the control module 110 to specify or identify a target administrative district corresponding to the object from an image on which the object is displayed, the control module 110 may first perform recognition on a predefined administrative district display area.

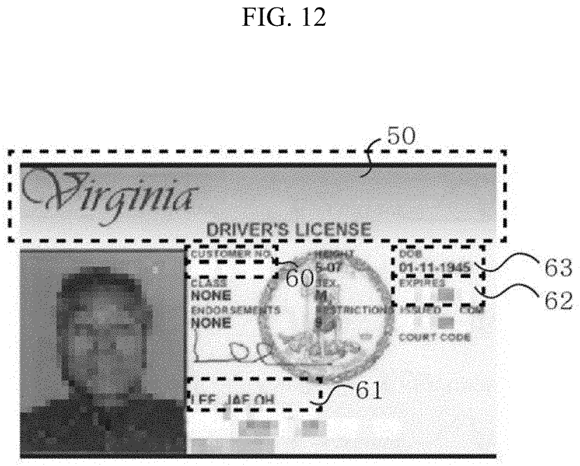

The administrative district display area is commonly applied in advance according to the type of an object, and may be an area in which information that can specify or identify the administrative district is displayed. For example, in the case of US driver's license cards, as shown in FIGS. 12 to 14, administrative districts may be commonly displayed in upper areas of the driver license cards.

Accordingly, the control module 110 may obtain a recognition result of the recognition module 125 corresponding to the administrative district display area, and first specify or identify a target administrative district corresponding to the object.

In addition, the position of an object in an image detected by the detection module 115 may be firstly considered to specify or identify the administrative district display area.

The detection module 115 may perform a function of specifying the outer lines of the object according to the technical spirit described above. However, according to exemplary embodiments, the detection module 115 may specify the position, i.e., the outer lines, of the object in other ways, and in any method capable of performing the function of specifying or identifying the position of the object.

In addition, although the recognition module 125 may also recognize a recognition target object by performing local binarization, exemplary embodiments are not limited thereto. For example, recognition of the recognition target object may be performed in other methods (e.g., deep learning-based OCR, etc.), and in any method capable of performing a function of recognizing a recognition target object existing in a specified area.

For example, the recognition module 125 may perform recognition on an administrative district display area or an area corresponding to a relative position specified by the control module 110, i.e., a target area.

Examples of recognizing an object having a different format according to each administrative district will be described below with reference to FIGS. 12 to 14.

FIGS. 12 to 14 are plan views illustrating a method of recognizing an object of a different format for each administrative district according to an exemplary embodiment.

As shown in FIGS. 12 to 14, the control module 110 may first specify or identify a target administrative district from an image in which an object (e.g., US driver's license card) is displayed. In order to specify or identify a target administrative district, it may be necessary to recognize information for specifying or identifying an administrative district.

Then, according to an exemplary embodiment, the control module 110 may set an administrative district display area 50.

The administrative district display area 50 may be defined as an area in which information for specifying or identifying an administrative district is displayed, and according to an exemplary embodiment, although the administrative district display area 50 may be defined as a rectangle having a predetermined area from the top of the object as shown in FIGS. 12 to 14, exemplary embodiments are not limited thereto.

Then, the control module 110 may acquire the position of an object (e.g., US driver's license card) specified by the detection module 115, i.e., the position of the outer line, and may set the administrative district display area 50 based on the position of the object.

In addition, the control module 110 may control the recognition module 125 to recognize the administrative district display area 50. Then, information indicating the administrative district may be identified from the text acquired as a result of performing the recognition, and the target administrative district of the object (e.g., US driver's license card) may be specified based on the identified result.

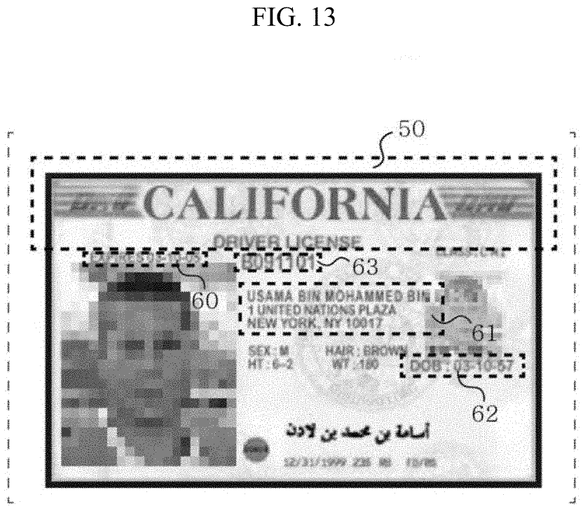

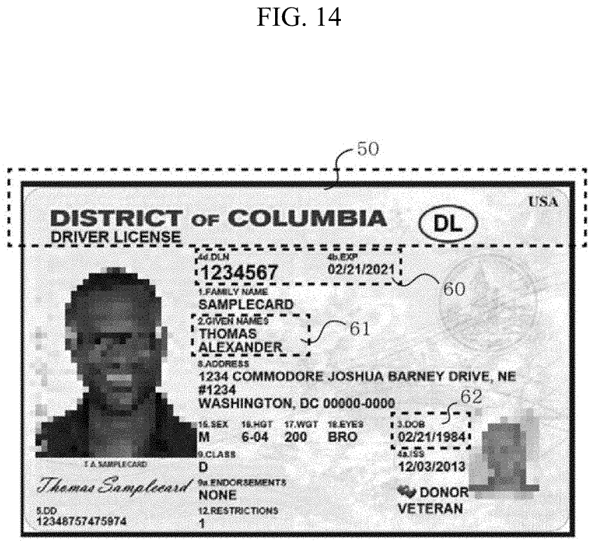

For example, the control module 110 may specify or identify Virginia state as a target administrative district in the object (e.g., US driver's license card) shown in FIG. 12, specify California state as a target administrative district in the object (e.g., US driver's license card) shown in FIG. 13, and specify Columbia as a target administrative district in the object (e.g., US driver's license card) shown in FIG. 14.

When a target administrative district is specified in this way, the control module 110 may specify a predetermined relative position, i.e., a position of area in which each target administrative district is recorded. For example, the control module 110 may use the position information of the object (e.g., US driver's license card) detected by the detection module 115.

In addition, the relative position of the area indicating each administrative district may be different according to each administrative district, and the number of relative positions may also be different according to each administrative district.

For example, in FIG. 12, each of the area 60 displaying the customer number (CUSTOMER NO.), the area 61 displaying the name, the area 62 displaying the expiration date (EXPIRES), and the area 63 displaying the date of birth (DOB) may be set as a target area corresponding to the relative position. Then, the recognition module 125 may recognize information displayed in the target area.

For example, compared with FIG. 12, it can be seen in FIG. 13 that the areas of different positions are set as target areas 60, 61, 62 and 63 corresponding to relative positions. It can be seen that the areas correspond to the expiration date 60, the name and address 61, the date of birth 62, and the driver license number 63.

In addition, as shown in FIG. 14, it can be seen that the positions of the target areas set in the object corresponding to FIG. 14 (e.g., US driver's license card) are also different from those shown in FIGS. 12 and 13. In addition, in FIG. 14, the area 60 in which the driver license number and the expiration date are displayed may be set as a target area. In addition, the areas corresponding to the name 61 or the date of birth 62 may be set as a target area, respectively.

In addition, target areas corresponding to the relative positions for recognizing a recognition target object according to each administrative district in various ways may be set variously, and the recognition target object, i.e., information to be recognized, may also be variously set according to exemplary embodiments.

As a result, according to the exemplary embodiments, when there are cases in which the format of an object (e.g., US driver's license card) is different according to each administrative district, there is an advantage that an object recognition performance is improved by specifying the administrative district first, and selectively performing recognition at the position where a recognition target object is displayed according to the specified administrative district.

The object recognition method according to an exemplary embodiment can be implemented as a computer-readable code in a computer-readable recording medium. The computer-readable recording medium includes all kinds of recording devices for storing data that can be read by a computer system. Examples of the computer-readable recording medium are ROM, RAM, CD-ROM, a magnetic tape, a hard disk, a floppy disk, an optical data storage device and the like. In addition, the computer-readable recording medium may be distributed in computer systems connected through a network, and a code that can be read by a computer in a distributed manner can be stored and executed therein. In addition, functional programs, codes and code segments for implementing the invention can be easily inferred by programmers in the art.

While the exemplary embodiments have been described with reference to the drawings, this is illustrative purposes only, and it will be understood by those having ordinary knowledge in the art that various modifications and other equivalent embodiments can be made.

According to the exemplary embodiments, there is an effect of detecting an object relatively accurately although the outer line of the object to be detected is detected broken and extracted not being clearly.

In addition, since binarization is performed using different binarization criteria in each area when the information displayed on an object is recognized, there is an effect of recognizing well a target to be recognized even when the target is greatly affected by a lighting environment according to a situation of the object or when there is a big difference in the characteristics of background locally.

In addition, there is an effect of improving recognition performance even in the case of an object having various formats by determining first an administrative district and specifying in advance a position to be recognized according thereto even when the format of the object is different for each administrative district.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method of recognizing an object having a different format according to each administrative district, the method comprising the steps of:
determining a target administrative district corresponding to the object based on an image of the object by an object recognition system;
determining a position of a recognition target object in the image of the object indicating the target administrative district by the object recognition system, the position of the recognition target object set before the step of determining the target administrative district; and
performing recognition of the recognition target object at the determined position by the object recognition system.

2. The method of claim 1, wherein the step of determining the target administrative district corresponding to the object based on the image of the object by the object recognition system, includes the steps of:
performing recognition of a predefined administrative district display area in the object; and
determining the target administrative district based on a result of performing the recognition of the predefined administrative district display area in the object.

3. The method of claim 1, further comprising the step of identifying an outer line of the object, wherein the object recognition system determines the target administrative district or the position of the recognition target object based on the identified outer line of the object.

4. The method of claim 3, wherein the step of identifying the outer line of the object includes the steps of:
extracting line segments from the image of the object;
generating merged line segments based on directionality of each of the extracted line segments;
identifying candidate outer lines with respect to the outer line of the object based on a line segment set including the generated merged line segments; and
determining the candidate outer lines as the outer line of the object based on whether or not the identified candidate outer lines correspond to an appearance attribute of the object.

5. The method of claim 1, wherein the step of performing the recognition of the recognition target object at the determined position by the object recognition system includes the steps of:
determining a target area corresponding to the position of the recognition target object;
setting a binarization area and a coefficient calculation area in a part of the target area, the coefficient calculation area including the binarization area and having an area wider than the binarization area by a predetermined ratio;
determining a binarization coefficient based on values of pixel images included in the coefficient calculation area; and
performing image binarization on the binarization area by using the determined binarization coefficient, wherein
the recognition of the recognition target object is performed based on a result of the image binarization on the binarization area.

6. A computer-readable recording medium installed in a data processing device configured to perform a method as in claim 1.

7. An object recognition system for recognizing an object having a different format according to each administrative district, the system comprising:
a control module configured to determine a position of a recognition target object in an image of the object indicating a target administrative district, the position of the recognition target object set before determining the target administrative district corresponding to the object; and
a recognition module configured to perform recognition of the recognition target object displayed at the determined position.

8. The system of claim 7, wherein the control module is configured to determine the target administrative district based on a result of the recognition of the recognition target object that is performed on a predefined administrative district display area in the object by the recognition module.

9. The system of claim 7, further comprising a detection module configured to identify an outer line of the object, wherein the control module is configured to determine the target administrative district or the position of the recognition target object based on the identified outer line of the object.

10. The system of claim 9, wherein the detection module is configured to extract line segments from the image of the object, to generate merged line segments based on directionality of each of the extracted line segments, to identify candidate outer lines with respect to the outer line of the object based on a line segment set including the generated merged line segments, and to determine the candidate outer lines as the outer line of the object based on whether or not the identified candidate outer lines correspond to an appearance attribute of the object.

11. The system of claim 7, wherein the recognition module is configured to determine a target area corresponding to the position of the recognition target object, to set a binarization area and a coefficient calculation area in a part of the target area, the coefficient calculation area including the binarization area and having an area wider than the binarization area by a predetermined ratio, to determine a binarization coefficient based on values of pixel images included in the coefficient calculation area, to perform image binarization on the binarization area by using the determined binarization coefficient, and to perform the recognition of the recognition target object based on a result of the image binarization on the binarization area.
